(19) United States
(12) Patent Application Publication
(10) Pub. No.: US 2026/0346741 A1
(43) Pub. Date: Nov. 5, 2026

(54) METHOD FOR CHARGING AN ELECTRIC VEHICLE

(71) Applicant: Ford Global Technologies, LLC, Dearborn, MI (US)

(72) Inventors: Thomas Coupar, Ann Arbor, MI (US); James Marcicki, Beverly Hills, MI (US); Jennifer Miller, Royal Oak, MI (US); Hao Wu, Northville, MI (US); Gabrielle Vuylsteke, Ferndale, MI (US); Donnell Washington, Northville, MI (US)

(21) Appl. No.: 19/196,555

(22) Filed: May 1, 2025

(51) Int. Cl. B60L 53/10; B60L 53/65

(52) U.S. Cl. CPC B60L 53/11; B60L 53/65; B60L 2240/545; B60L 2240/547; B60L 2240/549

(57) ABSTRACT

Systems and methods are provided for reducing an amount of time taken to charge an electric vehicle while preserving a useful life of a battery of the electric vehicle, by selecting a direct current fast charging profile to use for charging based on factors including an initial state of charge of the battery.

### FIELD

The present description relates generally to methods and systems for increasing a speed of charging an electric vehicle.

### BACKGROUND/SUMMARY

A plug-in electric vehicle (EV) operates on electricity stored in one or more batteries of the EV. When the stored electricity decreases below a threshold, the one or more batteries may be recharged at a charging station. The EV may be charged using an onboard alternating current (AC) battery charger of the EV, or the EV may be charged using direct current fast charging (DCFC). During DCFC charging, a DCFC system may output a direct current (DC) output at a voltage corresponding to the one or more batteries, which may charge the EV faster than an AC output. During DCFC charging, a DCFC current limit may first be selected for charging the EV. The EV may then be charged in accordance with the DCFC current limit, meaning, a current that does not exceed the DCFC current limit for the battery (other limits may be imposed by other components of the charging station and/or vehicle). The DCFC current limit used for charging the EV may be selected based on various factors, such as battery temperature, charge rate capability of a battery cell, and a design life of the battery.

In one example, the issues described above could be at least partially addressed by a method for charging an electric vehicle using direct current fast charging, the method comprising initiating charging of a battery of the EV with a first charging current that is less than or equal to a first current limit generated based on an initial state of charge of the battery prior to receiving a charge from the charger; and continuing charging the battery with a second charging current that is less than or equal to a second current limit with a measured state of charge of the battery above a threshold state of charge, the second charging current less than or equal to the first charging current and the second current limit based on the initial state of charge, the second current limit less than or equal to the first current limit.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an exemplary electric vehicle charging system;

FIG. 2 is a flowchart illustrating an exemplary method for fast-charging a battery of an EV using a DCFC current limit selected based on an initial SOC of the EV;

FIG. 3 is a flowchart illustrating an exemplary method for determining and storing in one or more lookup tables a set of current limits for charging the battery;

FIG. 4 is a graph showing an exemplary model for estimating when an anode potential of the battery is favorable for lithium plating;

FIG. 5 shows a first exemplary lookup table for determining a current limit for charging an EV battery based on temperature and measured cell voltage of the battery, and a second lookup table for determining a voltage adjustment to be applied when using the first lookup table, based on the initial SOC of the battery;

FIG. 6 shows a plurality of exemplary lookup tables for determining a current limit for charging an EV battery based on an initial SOC of the battery;

FIG. 7A shows a first timing diagram indicating a first sequence of events when charging the EV, when the EV has a first initial SOC;

FIG. 7B shows a second timing diagram indicating a second sequence of events when charging the EV, when the EV has a second initial SOC;

FIG. 7C shows a third timing diagram indicating a third sequence of events when charging the EV, when the EV has a third initial SOC; and

FIG. 8 shows two exemplary graphs showing a savings in time for charging the EV generated by using different DCFC charging current limits based on the initial SOC of the battery.

### DETAILED DESCRIPTION

Systems and methods are provided for decreasing an amount of time taken to charge an electric vehicle (EV) while preserving a useful life of a battery of the EV, by selecting a direct current fast charging (DCFC) profile to use for charging the EV based on an initial state of charge (SOC) of the battery.

For EV batteries, it may be desirable for the charging of the battery not to last considerably longer than the filling process for a vehicle operated by internal combustion engine. However, high charging currents (e.g., 300-400 A) are relied on for this, which can lead to intense self-heating and thus to increasing degradation of the battery and accelerated aging of the battery. Furthermore, at high currents, in addition to intercalation, there is the potential that metallic lithium is also deposited (Li plating) at the anode, which in turn can lead to internal short circuits. Additionally, suitable rapid-charging conditions may depend on the state of health (SOH) of the battery.

In current rapid-charging methods, EVs may be charged in accordance with one or more DCFC profiles, which establish charging parameters (e.g., current and voltage limits) used for charging. To reduce the degradation caused by the high currents, the DCFC current limit used to charge an EV may be adjusted as charging conditions change during charging. For example, the DCFC current limit may be adjusted based on an SOC of the battery during charging, also referred to herein as an operating SOC or simply SOC, which may be determined from a voltage of the battery. Because electrolyte degradation can be facilitated in connection with a high charging current at high temperatures and Li plating can occur at low temperatures, the charging current used may also depend on a measured temperature of the battery. At a low SOC, the battery may first be charged using a constant charging current (CC) in accordance with a first DCFC current limit. When a first threshold SOC is achieved, the CC charging may be continued at a lower charging current in accordance with a second DCFC current limit. When a second threshold SOC is achieved, the CC charging may be continued with a constant voltage (CV) defined by a third DCFC current limit. The CC charging may continue until a predetermined target SOC (e.g., a target voltage) is achieved. By adjusting the DCFC current limit at different SOCs, a charging time of the battery may be reduced, and a useful life of the battery may be maintained or increased.

In addition to the operating SOC and a battery temperature, a SOH of the battery may be an additional factor considered in determining a maximum charging current and/or maximum charging rate and the thresholds. However, other factors that are not currently considered may also influence charging times. In particular, charging times may also depend on an initial SOC (SOCi) of the battery. Current DCFC charging current limits are typically designed around a 10% SOCi, but a majority of DCFC events observed in practice begin at much higher SOCi values (e.g., a median SOCi of 30%). Charging an EV when the SOCi is 30-80% of battery capacity may result in faster charging than charging the EV at initial SOCs of less than or equal to 30% for the same SOC window.

To take advantage of the potential time savings in fast charging represented by incorporating the SOCi into DCFC current limit adjustment, a method is proposed herein for the dynamic selection of DCFC charging current limits based on factors including the SOCi. A physical battery model is developed and calibrated to predict when an anode potential of a battery is favorable for lithium plating, based on factors including temperature, charging rate, and SOCi. A physical battery model is an alternative to an empirical model (e.g. machine learning or equivalent circuit model), where the structure/equations that make up a physical battery model are based on physics. The physical battery model is a model that is based on a set of partial differential equations (PDEs) that describe reaction kinetics at electrolyte/electrode interfaces, and the transport of ions and electrons within the electrodes, electrolyte, and separator of a battery. The physical battery model may be a one-dimensional model, or a multi-dimensional model that takes into account a height, width, and thickness of a battery. The three dimensional reality of a battery may be simplified to include the direction of the reaction, considering thickness but without considering a variation in the width or height.

While the physical battery model is referred to herein, it should be appreciated that in some examples, the prediction of when the anode potential of the battery is favorable for lithium plating based on factors including temperature, charging rate, and SOCi may be made using experimental values rather than the physical battery model. In other words, the anode voltage may be measured under laboratory conditions, based on a reference electrode added to the battery cell.

In one example, a first lookup table is generated based on the calibrated model that specifies a DCFC current limit to use when charging the battery, based on a temperature of the battery and a measured cell voltage of the battery (e.g., corresponding to the SOC of the battery). A second lookup table is generated that indicates an adjustment to be made to the measured cell voltage prior to determining the charging current using the first lookup table, where the adjustment is based on a measured SOCi prior to charging. In this way, the first lookup table and the second lookup table are used in conjunction to determine an appropriate DCFC current limit to use for charging the battery. By using both of the first and second lookup tables, as opposed to using only the first lookup table, a charging rate of the battery may be increased, and a charging time of the battery may be reduced.

In another example, a plurality of lookup tables may be generated using the model, where each lookup table of the plurality of lookup tables corresponds to a different range of SOCi values. That is, when a battery is in a first range of SOCi values, a first lookup table is used to determine the charging current, based on the temperature and measured cell voltage; when the battery is in a second range of SOCi values, a second lookup table is used to determine the charging current, based on the temperature and measured cell voltage; when the battery is in a third range of SOCi values, a third lookup table is used to determine the charging current, based on the temperature and measured cell voltage; and so on.

In another example, the calibrated physical battery model (or calibration method that leverages experimental measurements directly) is used to train a computational model, such as a machine learning (ML) model, to predict the current limit based on the SOCi, measured voltage, and battery temperature. Other inputs, such as the operating SOC and a battery SOH, may also be used. In still another example, a transfer function may be generated from the calibrated physical battery model, which may be used to calculate the current limit based on the SOCi, measured voltage, battery temperature, and/or other inputs.

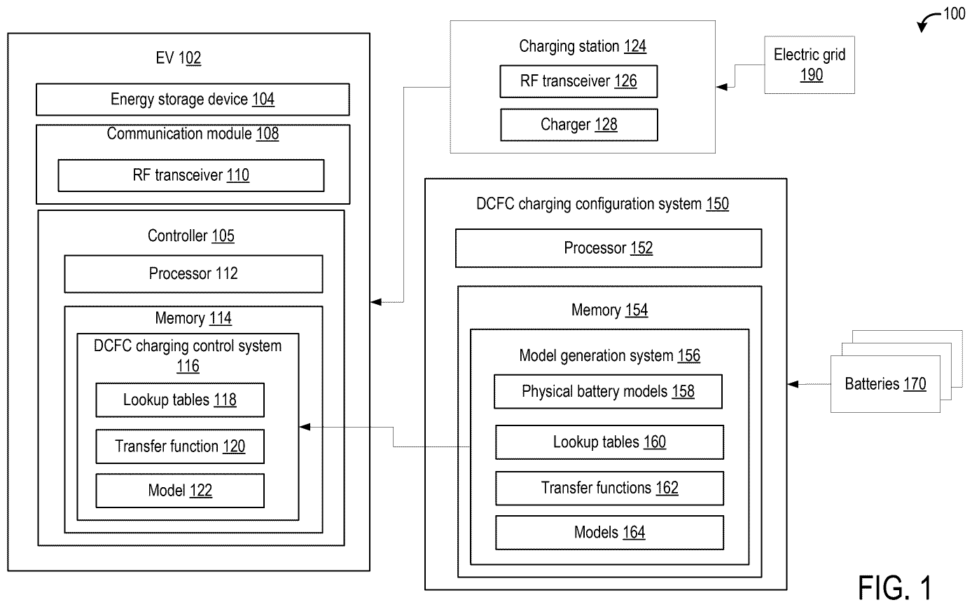

Referring now to the figures, FIG. 1 shows an electric vehicle charging system 100, including an EV 102, a charging station 124 electrically connected to an electric grid 190, and a DCFC charging configuration system 150 that may generate and store charging parameters for a plurality of batteries 170. EV 102 may be a plugin hybrid vehicle, a range extended hybrid vehicle, an electric traction or battery or plugin vehicle, or a different type of electric vehicle. EV 102 may be a car, light or heavy truck, bus, or any other type of vehicle operated on roadways and charged via an electric charging station. In some embodiments, EV 102 may be owned and operated by a user (e.g., a driver). In other embodiments, EV 102 may be owned by a first party and operated by a second party. In various embodiments, EV 102 may be owned by a company and operated by an employee of the company. For example, EV 102 may be one of a plurality of EVs of a vehicle fleet managed by the company (e.g., rental cars, delivery vehicles, buses, etc.).

EV 102 includes at least one energy storage device 104, such as a traction battery, that stores electricity used to propel wheels of EV 102. The electricity may be received by energy storage device 104 when EV 102 is charged, for example, at a charging station (e.g., charging station 124), or when plugged into an electric grid (e.g., electric grid 190) via a power outlet such as at a home of a driver of EV 102.

EV 102 may include a communication module 108, which may control a communication between one or more controllers of EV 102 and external elements of infrastructure. The external elements of infrastructure may include one or more charging stations, such as charging station 124. The communication may include wired communication, for example, via a cable communicatively coupling EV 102 with charging station 124, or the communication may include wireless communication, for example, via a modem, or via a radio frequency (RF) transceiver 110. For example, EV 102 may communicate with charging station 124 (for example, during a charge event) via Bluetooth®, or via a different RF protocol.

Communication module 108 may facilitate transmission of various types of electronic data within and/or among one or more systems of EV 102 and/or electric vehicle charging system 100 of FIG. 1. Communication module 108 may also facilitate wireless transmission of electronic data between EV 102 and charging station 124. Communication via the communication module can be implemented using one or more protocols. The communication module can include a wired interface (e.g., a data bus, a Universal Serial Bus (USB) connection, etc.) and/or a wireless interface (e.g., radio frequency, infrared, near field communication (NFC), etc.). For example, the communication module may communicate via wired local area network (LAN), wireless LAN, wide area network (WAN), etc. using any past, present, or future communication protocol (e.g., BLUETOOTH™, USB 2.0, USB 3.0, etc.). Communication module 108 may be used to send instructions to charging station 124 for charging EV 102, and/or to provide charging information to charging station 124 upon request. For example, the charging information may include one or more current limits to be applied when charging EV 102.

Controller 105 may include one or more processors 112 and a memory 114. The one or more processors 112 may be single core or multi-core, and the programs executed thereon may be configured for parallel or distributed processing. In some embodiments, the one or more processors 112 may optionally include individual components that are distributed throughout two or more devices, which may be remotely located and/or configured for coordinated processing. In some embodiments, one or more aspects of the one or more processors 112 may be virtualized and executed by remotely-accessible networked computing devices configured in a cloud computing configuration.

In some embodiments, memory 114 may include components disposed at two or more devices, which may be remotely located and/or configured for coordinated processing. In some embodiments, one or more aspects of memory 114 may include remotely-accessible networked storage devices configured in a cloud computing configuration.

Memory 114 may store a DCFC charging control system 116, which may provide charge balancing between various storage elements (e.g., battery cells) of energy storage device 104 and communication with other vehicle controllers. A flow of power into and out of electric energy storage device 104 may be controlled by DCFC charging control system 116, or by a power distribution module of DCFC charging control system 116. Memory 114 may additionally include charge event parameters and/or historical charge information, such as charging time information, including starting times and ending times of charge events, and ignition-on/ignition-off times; a charging energy source type, a charge amount, an operating SOC of energy storage device 104, and/or other parameters.

Charging station 124 may be installed at a residential home or outside a residential home, for example, at a public (e.g., non-networked) or private (e.g., networked) charging station. Charging station 124 may a DCFC-enabled charging station, where EV 102 may receive a charging current from charging station 124 via DCFC fast charging. Charging station 124 includes a charger 128, which may be a DCFC charger.

Controller 105 may transmit information to and/or receive information from charging station 124 via communication module 108. The information exchanged between EV 102 and charging station 124 may include information about a battery of EV 102 during a charge event. During a charge event, EV 102 may be coupled to charging station 124 via a charging cable and may receive a charging current from charging station 124 via the charging cable. The charging current received from charging station 124 may be supplied by electric grid 190. During charging, EV 102 may exchange information of the charge event (e.g., battery charging parameters, charging data and feedback, vehicle system data) with charging station 124 via the charging cable. In some embodiments, EV 102 may additionally or alternatively exchange the information with selected charging station 124 directly over a wireless network. In other embodiments, EV 102 may additionally or alternatively communicate and/or exchange information with selected charging station 124 via radio frequency (RF) signals. For example, charging station 124 may include a second RF transceiver 126, where information of EV 102 may be sent from first RF transceiver 110 to second RF transceiver 126, and/or information of charging station 124 may be sent from second RF transceiver 126 to first RF transceiver 110. For example, the information may be exchanged via a wireless electronic device interconnector, such as a Bluetooth® connection. In other embodiments, EV 102 may communicate and exchange information with selected charging station 124 via a wired connection other than the charging cable, or via a different type of wireless communication.

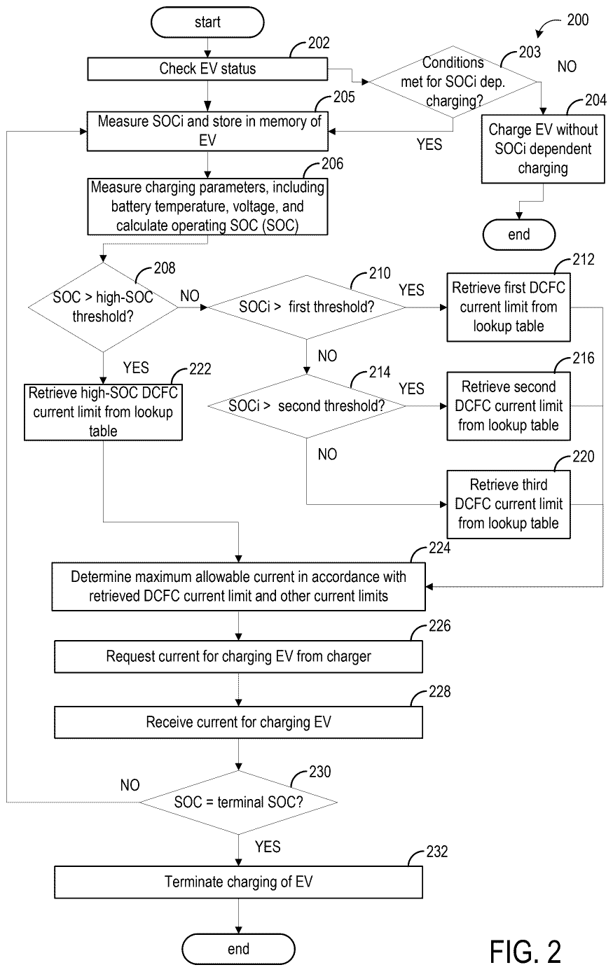

DCFC charging control system 116 may store one or more lookup tables 118, which may be used to determine one or more DCFC charging current limits to use while charging EV 102. Prior to DCFC charging via charger 128, DCFC charging control system 116 may retrieve an initial DCFC current limit from the one or more lookup tables 118. DCFC charging control system 116 may send the initial DCFC current limit to charger 128. Charger 128 may initiate charging of EV 102 using a current that does not exceed the initial DCFC current limit. During charging of EV 102, DCFC charging control system 116 may retrieve a second, different DCFC current limit from the one or more lookup tables 118. For example, DCFC charging control system 116 may retrieve the second DCFC current limit from the one or more lookup tables 118 in response to a threshold voltage or SOC of energy storage device 104 being achieved, or in response to a different parameter or criteria being achieved. The second DCFC current limit may be less than or equal to the initial DCFC current limit. In other words, as the SOC of energy storage device 104 increases, the current used to charge EV 102 may be reduced, to ensure that battery degradation and conditions for lithium plating are minimized and to protect a health of energy storage device 104. DCFC charging control system 116 may send the second DCFC current limit to charger 128. Charger 128 may adjust charging of EV 102, using a current that is less than or equal to or equal to the second DCFC current limit (e.g., a reduced current). Additional DCFC charging current limits retrieved from lookup tables 118 may be communicated to charger 128 during charging in a similar fashion. The DCFC charging current limits may be retrieved from lookup tables 118 based on charging parameters including voltage, SOC, initial SOC prior to charging, temperature of energy storage device 104, and/or other factors, as described below in accordance with method 200 of FIG. 2.

In some embodiments, DCFC charging control system 116 may additionally or alternatively store one or more of a transfer function 120 and/or a model 122, which may output a DCFC current limit based on inputs including the SOC, initial SOC prior to charging, temperature of energy storage device 104, voltage, and/or other factors. That is, in some embodiments, transfer function 120 or model 122 may be used to determine the DCFC current limit to apply while charging EV 102 rather than lookup tables 118. Model 112 may comprise one or more of various types of models. For example, model 112 may be a statistical model, a rules-based model, a probabilistic model, a machine learning (ML) model such as a deep learning model, or a different type of model. In some examples, transfer function 120 may still rely on one or more lookup tables for retrieving coefficients of transfer function 120.

Lookup tables 118, transfer function 120, and model 122 may be provided by DCFC charging configuration system 150. DCFC charging configuration system 150 includes a processor 152 and a memory 154. As with processor 112, processor 152 may be single core or multi-core, and the programs executed thereon may be configured for parallel or distributed processing. In some embodiments, processor 152 may optionally include individual components that are distributed throughout two or more devices, which may be remotely located and/or configured for coordinated processing. In some embodiments, one or more aspects of processor 152 may be virtualized and executed by remotely-accessible networked computing devices configured in a cloud computing configuration. Memory 154 may also include components disposed at two or more devices, which may be remotely located and/or configured for coordinated processing.

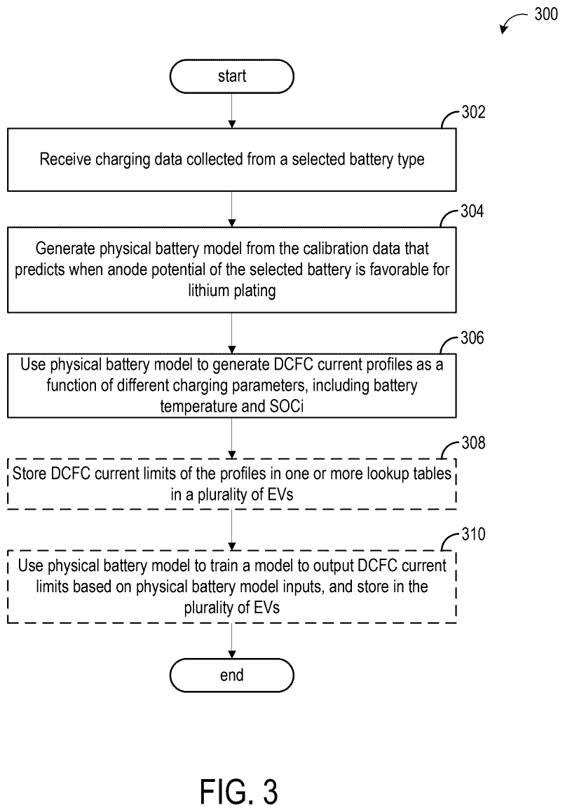

Memory 154 includes a model generation system 156 configured to generate a plurality of lookup tables 160, transfer functions 162, and machine learning (ML) models 164 for a respective plurality of batteries 170. That is, for a battery 170 (e.g., energy storage device 104), DCFC charging configuration system 150 may generate one or more lookup tables 160, a transfer function 162, or an model 164 that may indicate appropriate DCFC charging current limits to use for charging the battery 170. For such purpose, model generation system 156 may store a respective plurality of physical battery models 158 of the battery 170, which may be used to generate the lookup tables 160, transfer function 162, and/or model 164 for a respective plurality of types of batteries 170. The generation of the lookup tables 160, transfer function 162, and model 164 is described in greater detail in reference to FIG. 3.

FIG. 2 shows an exemplary method 200 for selecting a DCFC current limit for charging an EV, such as EV 102 of FIG. 1, at a DCFC-enabled charging station (e.g., charging station 124). Method 200 may be performed by a processor of the EV (e.g., processor 112), based on instructions stored in a memory of the EV (e.g., DCFC charging control system 116). Method 200 may be performed when the EV is communicatively coupled to a charger (e.g., charger 128) of the charging station, prior to and when receiving a charging current from the charger.

Method 200 begins at 202, where method 200 includes checking a status of the vehicle, and at 203, method 200 includes determining whether conditions are met for charging the vehicle using SOCi-dependent charging. Checking the status of the vehicle may include checking, for example, a contactor status (e.g., open or closed), a key status (e.g., on or off), a critical high voltage battery fault status, and/or a time since any change in status. For example, if the charge contactor is open, the high voltage battery may not be ready to charge and DCFC charging may not proceed. If time since a change in the charge contactor status indicates that a DCFC event appeared to complete within the last 20 minutes, the initial SOC from that event may carryover to this event. If there is a high voltage battery related fault indicating that non-routine service is required, SOCi dependent DCFC may be turned off or DCFC may be otherwise limited until the issue is resolved.

If at 203 conditions are not met for SOCi-dependent charging, method 200 proceeds to 204, where method 200 includes charging the EV without using the SOCi-dependent charging algorithm described herein. In such cases, method 200 ends. Alternatively, if at 203 conditions are met for SOCi-dependent charging, method 200 proceeds to 205.

At 205, method 200 includes measuring an SOCi of a battery of the vehicle (e.g., energy storage device 104). The SOCi may be a state of charge of the battery prior to beginning charging of the EV. At 206, method 200 includes measuring charging parameters of the EV used to configure the charger to deliver a suitable charging current to the EV. The charging parameters may include a temperature of the battery. The temperature of the battery may be provided by a temperature sensor positioned within or on the battery cell. The charging parameters may include a voltage of the battery. An operating SOC of the battery during charging may be calculated using current integration, the measured voltage and the temperature. The SOC may be expressed as a percentage of a total charge capacity of the battery. For example, the SOC may be 50%, where the battery has 50% of total charge capacity. Prior to starting charging the battery, the SOC may be equal to the SOCi measured at 202. During charging of the battery, the SOC may increase up to a maximum voltage corresponding to the charge capacity of the battery.

At 208, method 200 includes determining whether the SOC is greater than a high-SOC threshold. The high-SOC threshold may be a threshold at which continued charging of the battery may increase a potential for lithium plating and a consequent degradation of the battery. In various embodiments, the high-SOC threshold is 80% of the charge capacity of the battery. When the high-SOC threshold is achieved, the charge current used to charge the battery may be severely de-rated to protect the health of the battery. Thus, if at 208 it is determined that the operating SOC is greater than the high-SOC threshold, method 200 proceeds to 222. At 222, method 200 includes retrieving a high-SOC DCFC current limit from a first lookup table (e.g., lookup tables 118) stored in the memory. The high-SOC DCFC current limit may be lower than a current limit used to charge the battery up to the high-SOC threshold. For example, the high-SOC DCFC current limit may be 20 A.

Alternatively, if at 208 it is determined that the operating SOC is not greater than the high-SOC threshold, method 200 proceeds to 210. At 210, method 200 includes determining whether the SOCi is greater than a first threshold. If at 210 the SOCi is greater than the first threshold, method 200 proceeds to 212, where method 200 includes retrieving a first DCFC current limit from a lookup table stored in a memory of the EV (e.g., of lookup tables 118). Alternatively, if at 210 the SOCi is not greater than the first threshold, method 200 proceeds to 214, where method 200 includes determining whether the SOCi is greater than a second threshold.

If at 214 the SOCi is greater than the second threshold, method 200 proceeds to 216, where method 200 includes retrieving a second DCFC current limit from the lookup table. If at 214 the SOCi is not greater than the second threshold, method 200 proceeds to 220, where method 200 includes retrieving a third DCFC current limit from the lookup table.

After a DCFC current limit has been retrieved from the lookup table, at one of steps 222, 212, 216, or 220, method 200 proceeds to 224. At 224, method 200 includes determining a maximum allowable current to be used to charge the EV, in accordance with the retrieved DCFC current limit. In some examples, other current limits may be taken into consideration, such as present battery temperature, recent battery usage, battery SOH, and vehicle system constraints to further reduce the DCFC current and protect vehicle systems.

At 226, method 200 includes requesting a current for charging the EV from the charger, and at 228, method 200 includes receiving the current for charging the EV from the charger. The battery of the EV may be charged using the current.

At 230, method 200 includes determining whether the SOC of the battery is equal to a terminal SOC of the battery, where the terminal SOC is a maximum SOC desired for the battery. The maximum SOC may be a customer-set target. The terminal SOC may or may not be equal to a charging capacity of the battery.

If at 230 the SOC is equal to the terminal SOC, method 200 proceeds to 232, where method 200 includes terminating charging of the EV, and method 200 ends. Alternatively, if at 230 the SOC is not equal to the terminal SOC, method 200 proceeds back to 204, and the charging parameters of the battery continue to be measured and monitored as charging continues.

Thus, method 200 describes an iterative or cyclical procedure for dynamically selecting a most appropriate current limit for charging the vehicle, based on an operating SOC during charging and the initial SOC prior to charging the EV. As the EV charges, the method continuously monitors the SOC to determine whether the high-SOC threshold has been met. While the operating SOC is less than or equal to the high-SOC threshold, a suitable DCFC current limit to be applied when charging the EV is selected from the lookup table based on the initial SOC. Other factors may also be considered, such as a temperature of the battery, a state of health (SOH) of the battery, etc. When the high-SOC threshold is achieved, the high-SOC DCFC current limit is applied, without considering the SOCi thresholds. It should be appreciated that while method 200 describes retrieving one of three different current limits, based on two SOCi thresholds, in other embodiments, a greater number of current limits may be applied based on a greater number of SOCi thresholds. In this way, a current limit may be selected for charging the EV, based on the SOCi and for the operating SOC, that results in a shortest feasible charging time of the battery. In this way, by dynamically selecting the most appropriate current limit for charging the vehicle, an overall charging time of the EV may be reduced and/or minimized.

The current limits to be applied may be stored in a single lookup table, as described above, or the current limits may be stored in a plurality of lookup tables. For example, the first DCFC current limit may be selected from first lookup table based on a first SOCi; the second DCFC current limit may be selected from second lookup table based on a second, different SOCi; the third DCFC current limit may be selected from a third lookup table based on a third SOCi different from either or both of the first and second SOCis; and so on. The lookup tables are described in greater detail below in reference to FIGS. 3-6.

The lookup tables relied on by method 200 may be created by following a method shown in FIG. 3. Referring now to FIG. 3, a method 300 is shown for generating a set of DCFC charging current limits to apply when charging a battery of an EV, using a physical battery model of the battery. Method 300 may be performed by a processor of a system used to determine ideal parameter configurations for charging EV batteries, such as processor 152 of DCFC charging configuration system 150 of FIG. 1. Different battery models may be used for different types of battery. For example, method 300 may be performed a first time for a first battery type, that may generate the set of DCFC charging current limits when charging an EV having the first battery type; method 300 may be performed a second time for a second battery type, that may generate the set of DCFC charging current limits when charging an EV having the second battery type; and so on.

Method 300 starts at 302, where method 300 includes receiving calibration data collected from a selected battery type. The calibration data may include empirical lithium plating data, charging and discharging voltage and temperature data at varied rates and at temperature set points, degradation data, battery cell voltage data, and the like. The charging and discharging voltage and temperature data may include charge and discharge data from constant C-rate tests, based on current levels that are normalized to nominal cell capacity. These tests may cover the normal operating range of temperature and C-rates, for example, temperatures of −10, 0, 10, 25, and 45 °C, and C-rates of 0.3, 0.6, 1.0, 1.5, 2.0, and 2.5 C.

At 304, method 300 includes generating a physical battery model from the collected calibration data that predicts when an anode potential of the selected battery is favorable for lithium plating. Because cell impedance is not static (e.g. there is a component with a time constant), voltage and anode potential are path dependent and capturing this may allow condition-specific charge time benefits. Factors including temperature, C-rate, and initial SOC may be inputs to the physical battery model.

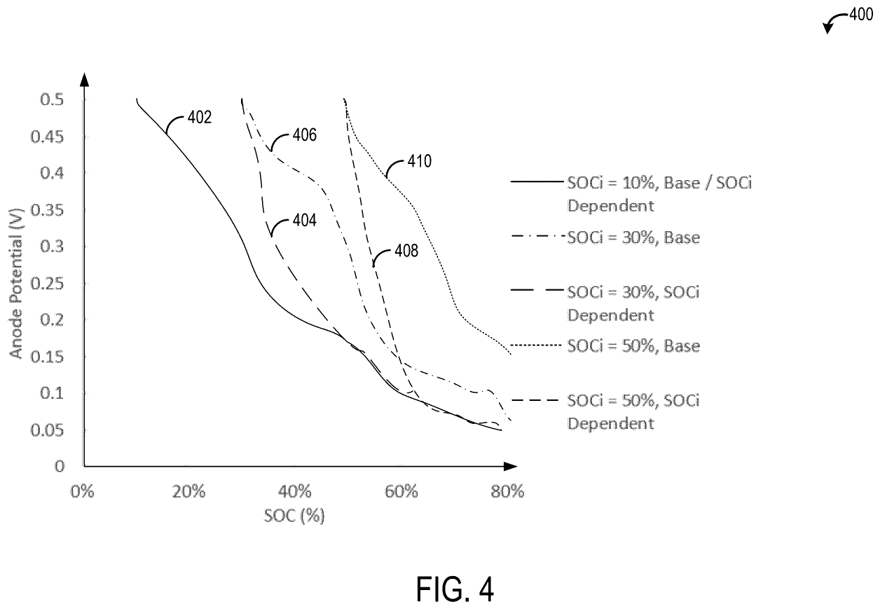

Referring briefly to FIG. 4, a graph 400 is shown that illustrates a relationship between the SOCi and lithium plating. Anode potential in volts is shown on the vertical axis, and the operating SOC during charging is shown on the horizontal axis. Graph 400 includes five lines:
a first line 402, indicating a first decrease in anode potential as the operating SOC increases during charging, based on applying the SOCi-dependent charging strategy described herein, when the SOCi is 10% of battery capacity;
a second line 404, indicating a second decrease in anode potential as the operating SOC increases during charging, based on applying the SOCi-dependent charging strategy described herein, when the SOCi is 30% of battery capacity;
a third line 406, indicating a third decrease in anode potential as the operating SOC increases during charging, when the SOCi-dependent charging strategy described herein is not applied, when the SOCi is 30% of battery capacity;
a fourth line 408, indicating a fourth decrease in anode potential as the operating SOC increases during charging, based on applying the SOCi-dependent charging strategy described herein, when the SOCi is 50% of battery capacity; and
a fifth line 410, indicating a fifth decrease in anode potential as the operating SOC increases during charging, when the SOCi-dependent charging strategy described herein is not applied, when the SOCi is 50% of battery capacity;

It should be appreciated that the thresholds of 30% and 50% are used for illustrative purposes herein, and in other examples, different percentage thresholds may be used without departing from the scope of this disclosure. For example, these values can be adjusted based on battery chemistry, an understanding of customer usage, capability of storing values in vehicle memory, etc.

As the operating SOC increases during charging, the anode potential decreases. Theoretically, an anode potential below 0V is favorable for lithium plating; practically, an offset may be desirable (e.g. li plating may be possible starting at a potential of 0.05V or less, OR may not be likely until a potential of −0.05V or less). When charging the EV, it is desirable to charge the EV using the highest current possible without allowing anode potential to decrease below a threshold value (e.g., for example, 0.05). Thus, FIG. 4 shows that if a Base (non-SOCi dependent) DCFC profile is used starting at a higher SOC (30% or 50% shown, 406 and 410), the anode potential doesn't reach low values at the same SOC as if it started at 10% SOC (402). This means there is margin that can be used to go faster, as shown in 404 and 408. In other words, for example with respect to line 410, as line 410 achieves 80% SOC with an anode potential of 0.15, a higher current could have been applied without lowering the anode potential below 0.05, which would have resulted in a faster charging rate.

Returning to method 300, at 306, method 300 includes using the physical battery model to generate a plurality of DCFC charging current profiles used to charge the battery as a function of different charging parameters of the battery type. The charging parameters may include temperature, SOC, SOCi, voltage, battery age, and/or other parameters. The profiles may indicate, for example, a suitable charging current limit for a measured SOC at various temperature ranges. From the profiles, suitable DCFC charging current limits to be applied during charging of the battery may be extracted. As mentioned above, in some examples an output of the physical battery model may be replaced or supplemented by experimental measurements.

At 308, method 300 includes optionally storing the DCFC charging current limits in one or more lookup tables in a plurality of EVs (e.g., in memory 114 of FIG. 1) having batteries of the battery type. The stored DCFC charging current limits may be retrieved from the lookup tables during charging of a respective EV, as described above in referenced to method 300 of FIG. 3. In some cases, the lookup tables may be used in conjunction with other current limit lookup tables created not using the physical battery model.

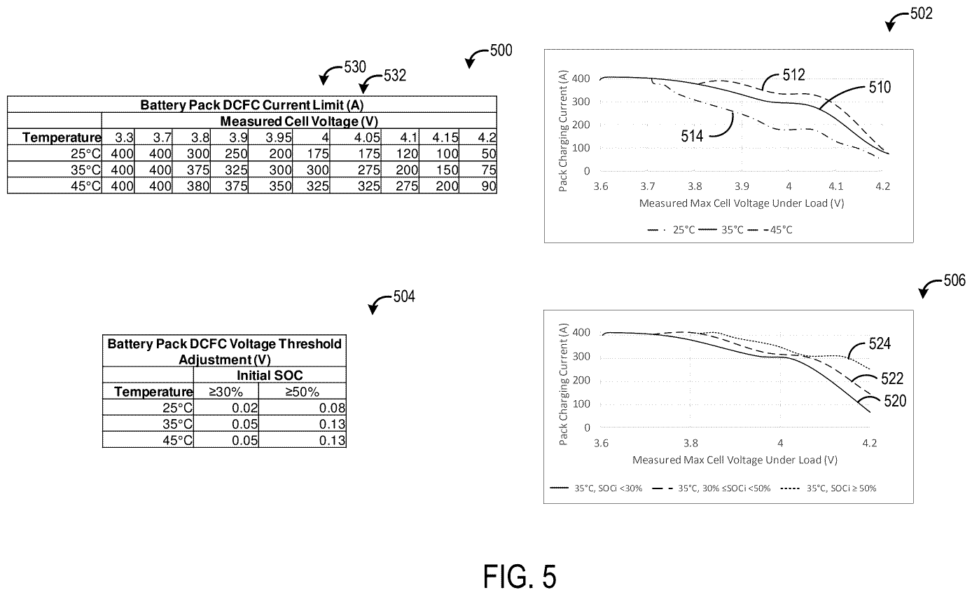

Referring briefly to FIG. 5, a first exemplary lookup table 500 is shown that may be generated without using the physical battery model, based on other methods rather than method 200 of FIG. 2. Lookup table 500 may be stored in the EV. During charging, an appropriate current limit may be retrieved from lookup table 500 based on the temperature of the battery and the measured cell voltage, and communicated to a DCFC charger providing a charging current. Lookup table 500 may be used in conjunction with a second lookup table 504, which may be populated with values generated using the physical battery model. During charging, an appropriate voltage threshold adjustment to be made to the measured cell voltage may first be retrieved from second lookup table 504, based on the SOCi and the temperature of the battery. The appropriate voltage threshold adjustment may be applied to (e.g., summed with) the measured cell voltage. A suitable DCFC current limit may then be retrieved from first lookup table 500 based on the temperature of the battery and the adjusted voltage after the summation. In this way, both lookup tables 500 and 504 may be used to determine the suitable DCFC current limit based on the SOCi. Using both lookup tables 500 and 504 may be a least computationally expensive implementation of a SOCi-dependent charging method such as method 200 of FIG. 2.

A first set of plots 502 shows an effect of applying the current limits retrieved from first lookup table 500 during charging the EV, where the current limits are generated not using method 200. The first set of plots 502 includes a first line 510, which shows the application of a first charging current used to charge the battery as a function of measured SOC (e.g., cell voltage under load) for a first temperature (35°). A second line 512 shows the application of a second charging current used to charge the battery as a function of measured SOC for a second temperature (45°). At the second temperature, the battery may be charged using a higher current than at the first temperature. A third line 514 shows the application of a third charging current used to charge the battery as a function of measured SOC for a third temperature (25°). At the third temperature, the battery may be charged using a lower current than at the first temperature.

A second set of plots 506 shows an effect of applying an adjustment retrieved from second lookup table 504 to the measured cell voltage, and then retrieving a current limit to apply when charging the battery from first lookup table 502 based on the adjusted cell voltage. Second set of plots 506 includes a first line 520 that indicates the application of a first charging current used to charge the battery as a function of measured SOC for a temperature of 35°when the SOCi is less than or equal to 30%. First line 520 may be the same as line 510 of the first set of plots 502. A second line 522 indicates the application of a second charging current used to charge the battery as a function of measured SOC for the temperature of 35°when the SOCi is between 30% and 50%. A third line 524 indicates the application of a third charging current used to charge the battery as a function of measured SOC for the temperature of 35°when the SOCi is greater than 50%. The second set of plots 506 shows that the SOCi-based voltage threshold adjustment can allow higher charging currents at the same operating SOC/voltage under load. For example, line 524 indicates that when the SOCi is above 50%, a higher current may advantageously be used to charge the battery than when the SOCi is below 50% (line 522) and below 30% (line 520).

It should be appreciated that in various examples, the DCFC current limit that is determined using the lookup table as described above may not correspond to a specific value included in the lookup table. For example, a DCFC current limit may be retrieved from the lookup table based on a measured cell voltage. The measured cell voltage may be 4.02. As the measured cell voltage is between a first cell voltage of 4.0 in a first column 530 of lookup table 500, and a second cell voltage of 4.05 in a second column 532, a current limit used to charge the battery may be an interpolation between 300 A (from column 530, for 35°) and 275 A (from column 532, for 35°), such as 290 A. In other examples, a “round down” approach where the lower of two current limits of a lookup table may be used to charge the battery; or a different strategy may be used to determine a suitable current limit based on values of the lookup table. Similarly, if the temperature of the battery is 30°, meaning, between 25°and 35°, a current limit may be selected between values included in different rows of the lookup table.

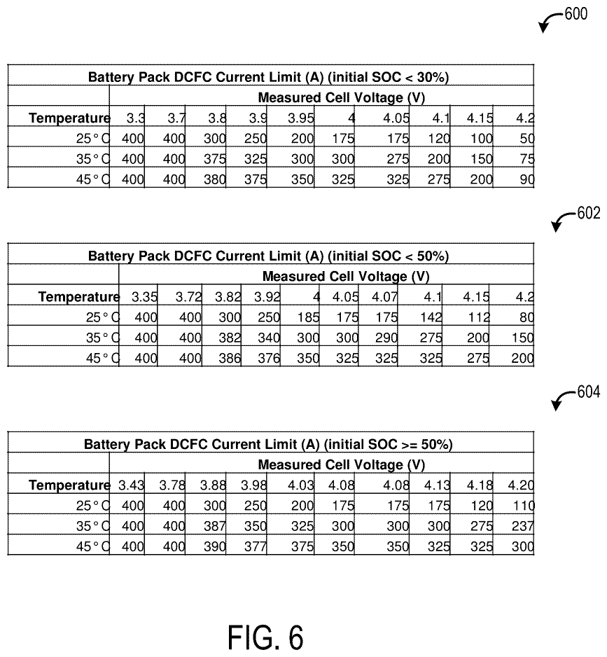

In some embodiments, the voltage threshold adjustment to be made to the measured voltage may be determined using a transfer function (e.g., transfer functions 162 of FIG. 1) corresponding to the battery type that is generated based on the SOCi and the battery temperature. Additionally or alternatively, the transfer function may be used to generate stand-alone tables such as tables 600, 602, and/or 604 of FIG. 6, described below The transfer function may be stored in the plurality of EVs and used as an alternative to second lookup table 504 or the tables of FIG. 6. The transfer function may rely on one or more separate lookup tables, from which coefficients of the transfer function may be retrieved during a use of the transfer function. The transfer function may be used to determine the DCFC charging current limits at the EVs when charging the battery type. An advantage of using the transfer function to determine the adjustment to the SOC rather than second lookup table 504 or the tables of FIG. 6 is that a more precise adjustment may be calculated, which may result in a faster charging rate.

In other embodiments, various lookup tables may be generated that specify suitable DCFC charging current limits for different SOCi ranges, as shown in FIG. 6. Referring now to FIG. 6, a first lookup table 600 indicates a first set of current limits that may be applied during DCFC charging of an EV battery, based on a temperature of the battery and a measured cell voltage (e.g., SOC) of the battery. A first current limit may be selected from first lookup table 600 when the SOCi of the battery is less than or equal to 30%. A second lookup table 602 indicates a second set of current limits that may be applied during DCFC charging of the same EV battery, also based on the temperature of the battery and the measured cell voltage of the battery, where a second current limit may be selected from second lookup table 602 when the SOCi of the battery is less than or equal to 50%, but greater than 30%. The second set of current limits permit charging of the EV battery at higher currents than lookup table 600 as the SOC of the battery increases. A third lookup table 604 indicates a third set of current limits that may be applied during DCFC charging of the same EV battery, also based on the temperature of the battery and the measured cell voltage of the battery, where a third current limit may be selected from third lookup table 604 when the SOCi of the battery is less than or equal to 80%, but greater than 50%. The third set of current limits permit charging of the EV battery at higher currents than lookup table 602 as the SOC of the battery increases. Each of first lookup table 600, second lookup table 602, and third lookup table 604 may be generated from values generated from the physical battery model.

Returning to method 300, at 310, method 300 optionally includes using data generated from the physical battery model (e.g., first set of plots 500, second set of plots 504, etc.) to train a model to output suitable DCFC charging current limits based on the inputs used by the physical battery model. That is, as an alternative to storing the current limits in the lookup tables described at 308, a trained model may be used to generate the current limits dynamically at the EV. The model may be a statistical model, or an ML model, or a different kind of model. The model may be trained using a combination of experimental data, such as degradation data, battery cell voltage data, and temperature data, and physical battery model data. For example, a trained model may take as input an SOCi, a measured cell voltage or SOC of the battery and a temperature of the battery, and may output either an appropriate charging current to use to charge the battery or an appropriate charging current limit to apply during charging of the battery. The model may be stored in the plurality of EVs, as an alternative to the lookup tables and/or the transfer function. The model may be used to determine the DCFC charging current limits at the EVs when charging the battery type. Method 300 ends.

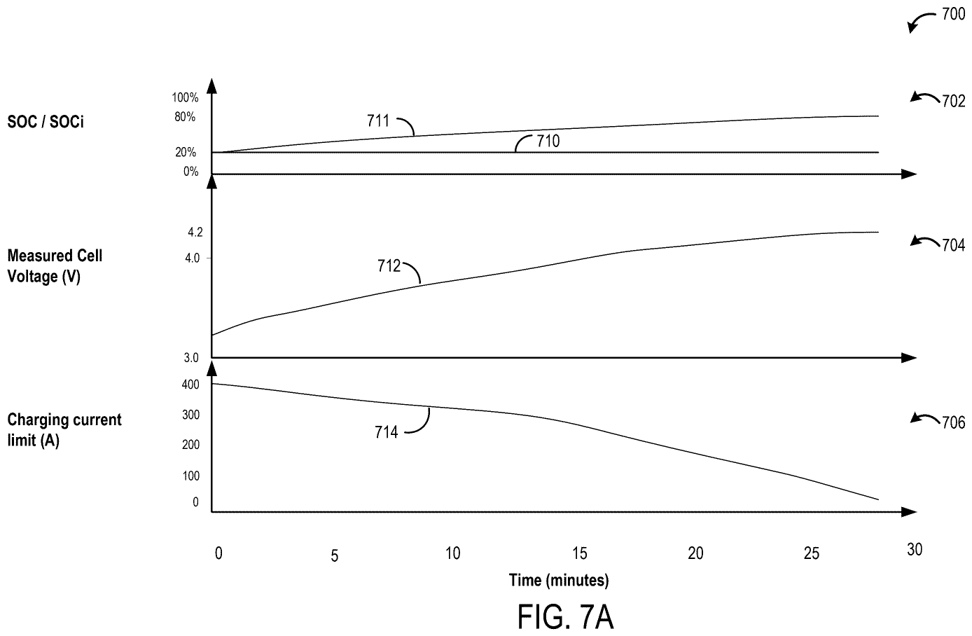

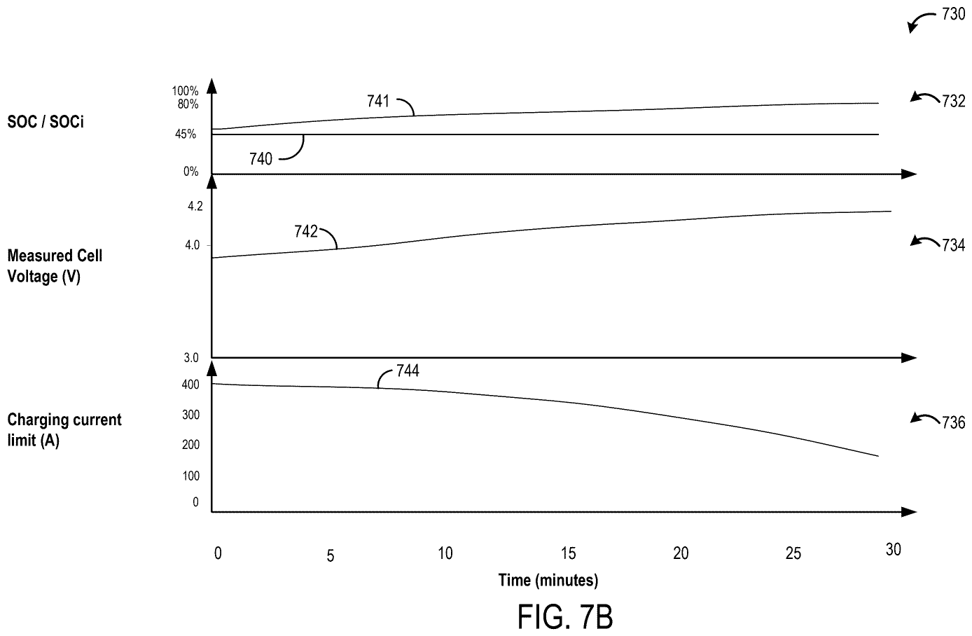

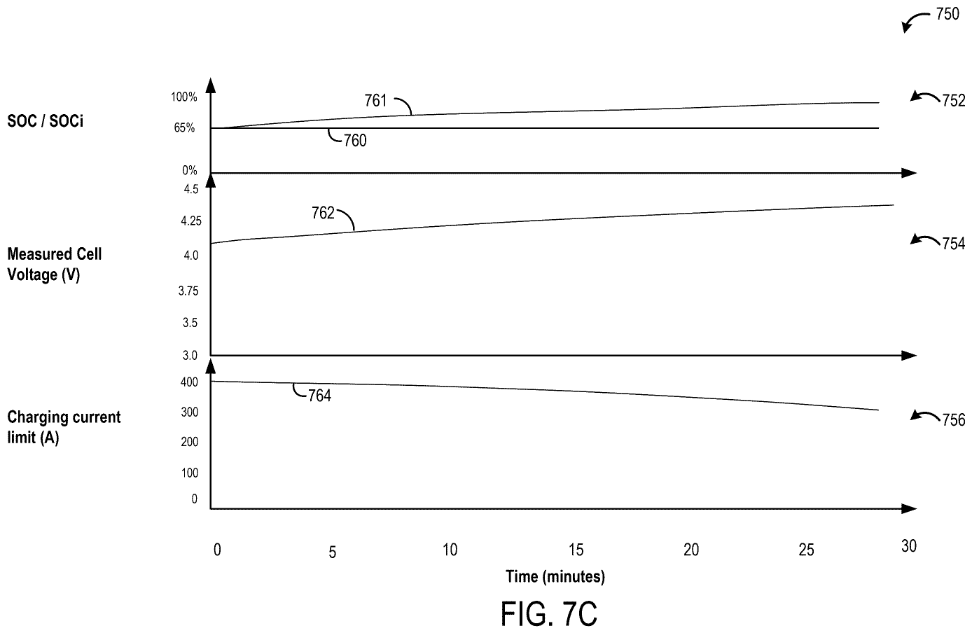

The adjustment of the charging current and/or charging current limits performed using the lookup tables or the model in accordance with method 200 of FIG. 2 may be further clarified by the timing diagrams shown in FIGS. 7A, 7B, and 7C.

FIG. 7A shows an exemplary timing diagram 700, showing a first exemplary sequence of events of during charging of an EV, such as EV 102 of FIG. 1, when the SOCi is less than or equal to 30%. As described above in reference to FIGS. 2 and 3, a physical battery model may be developed for a battery of the EV, from which current limits to be applied to the battery during charging may be determined and stored in a plurality of lookup tables. The current limits may be retrieved from the lookup tables during charging and communicated to the charger, in accordance with timing diagram 700. It should be appreciated that the current and voltage values described herein (based on the lookup tables of FIG. 6) are exemplary and for illustrative purposes; in other examples the current and voltage values may be different.

A horizontal (x-axis) of timing diagram 700 denotes time. Timing diagram 700 includes three plots. A first plot 702 includes a line 710 that shows an SOCi of the battery prior to charging. A line 711 shows an operational SOC during charging. A second plot 704 shows a line 712 that indicates a measured cell voltage of the battery during charging of the battery. A third plot 706 shows a line 714 that indicates a limit of a charging current (in amps) used to charge the battery, which may be based on an interpolation of values retrieved from a first lookup table (e.g., lookup table 600). Plots 702, 704, and 706 correspond to a battery temperature of 35 degrees. Different but similar plots may be substituted for different battery temperatures.

At time 0 the SOCi is measured at 20%, and charging commences with a charging current that does not exceed the current limit of 400 A, as shown by line 714. The current limit of 400 A may be retrieved from one or more lookup tables. An initial measured cell voltage may be 3.65, for example, based on the SOCi of 20%. As a result of the SOCi being less than or equal to 30%, the battery may be charged with the current limit of 400 A in accordance with lookup table 600 of FIG. 6. The battery receives the charge and the measured cell voltage increases.

The battery continues to be charged based on an interpolation of values retrieved from the first lookup table. That is, a row of the first lookup table corresponding to 35 °C includes various current limits based on corresponding cell voltages shown in various columns of lookup table 600. During charging of the battery, the various current limits may be retrieved and used to estimate a charging current limit to apply at a specific time.

For example, at a first time of 5 minutes after commencing charging, a first suitable charging current limit may be selected based on the first lookup table. A first measured cell voltage at 5 minutes may be greater than a first cell voltage threshold value and less than or equal to a second cell voltage threshold value included in the first lookup table. A first current limit associated with the first cell voltage threshold value may be retrieved from the first lookup table, and a second current limit associated with the second cell voltage threshold value may be retrieved from the first lookup table. The first suitable charging current limit may be selected by interpolating between the first current limit and the second current limit, or rounding down, or in a different manner. Similarly, the first suitable charging current limit may be selected by interpolating between temperatures of the first lookup table, or rounding down, or in a different manner.

At a time of 10 minutes after commencing charging, a second suitable charging current limit may be selected based on the first lookup table. A second measured cell voltage at 10 minutes may be greater than the second cell voltage threshold value and less than or equal to a third cell voltage threshold value included in the first lookup table. A third current limit associated with the third cell voltage threshold value may be retrieved from the first lookup table. The second suitable charging current limit may be selected by interpolating between the second current limit and the third current limit, and so on until the SOC has reached the high SOC threshold, for example, 80%, of the capacity of the battery. As a result of reaching the high SOC threshold of the battery, the current limit may be adjusted to a final current limit selected in accordance with the high-voltage lookup table (using interpolated or rounded values, as described above), to reduce lithium plating. For example, the final current limit may be 20 A. The battery may be charged in accordance with the final limit until charging is terminated.

In conventional charging systems, charging of the battery may be performed in accordance with timing diagram 700 at all initial SOC measurements. That is, the SOCi may not be used to adjust the current limits during charging, and current limits such as those described above may be used for charging batteries with different SOCi measurements. However, by adjusting the current limits for different SOCi values as described herein, a time taken to charge the battery may be reduced. FIGS. 7B and 7C show exemplary timing diagrams where the current limits are adjusted based on different SOCi ranges, in accordance with method 200 of FIG. 2 and lookup tables 602 and 604 of FIG. 6, respectively.

Turning now to FIG. 7B, a second exemplary timing diagram 730 shows a second exemplary sequence of events of during charging of the EV, when the SOCi is within a second range of SOCi values, between 30% and 50% of battery capacity. Timing diagram 730 includes three plots similar to timing diagram 700. A first plot 732 includes a line 740 that shows the SOCi of the battery prior to charging. A line 741 shows an operational SOC during charging. A second plot 734 shows a line 742 that indicates a measured cell voltage of the battery during charging of the battery. A third plot 736 shows a line 744 that indicates a limit of a charging current (in amps) used to charge the battery, which is based on interpolated values retrieved from a second lookup table (e.g., lookup table 602), as described above. Plots 732, 734, and 736 correspond to a battery temperature of 35 degrees.

At time 0 the SOCi is measured at 45%, and charging commences with a charging current that does not exceed the current limit of 400 A, as shown by line 744. As a result of the SOCi being greater than 30%, meaning, higher than in FIG. 7A, an initial measured cell voltage may be higher than in FIG. 7A. For example, the initial measured cell voltage may be 3.9V. As a result of the SOCi being greater than 30% and less than or equal to 50%, the battery may be charged with a current limit determined in accordance with the second lookup table. The battery receives the charge and the measured voltage increases. The battery continues to be charged based on an interpolation of values retrieved from the second lookup table. During charging of the battery, the various current limits may be retrieved and used to estimate a charging current limit to apply at a specific time, based on an interpolated or rounded measured cell voltage and temperature, as described above. Charging may continue until the high SOC threshold (e.g., 80%) of the battery is achieved, when the current limit may be adjusted to the final current limit selected in accordance with the high-voltage lookup table. The battery may be charged in accordance with the final limit until charging is terminated.

FIG. 7C shows a third exemplary timing diagram 750 indicating a third exemplary sequence of events of during charging of the EV, when the SOCi is within a third range of SOCi values, between 50% and 80% of battery capacity. Timing diagram 750 includes three plots similar to timing diagrams 700 and 730. A first plot 752 includes a line 760 that shows the initial SOCi of the battery prior to charging. A line 761 shows an operational SOC during charging. A second plot 754 shows a line 762 that indicates a measured cell voltage of the battery during charging of the battery. A third plot 756 shows a line 764 that indicates a limit of a charging current (in amps) used to charge the battery, which is based on an interpolation of values retrieved from a third lookup table (e.g., lookup table 604). Plots 752, 754, and 756 correspond to a battery temperature of 35 degrees.

At time 0, the SOCi is measured at 65%, and charging commences with a charging current that does not exceed the current limit of 400 A, as shown by line 764. As a result of the SOCi being 65%, meaning, higher than in FIG. 7A and FIG. 7B, an initial measured cell voltage may be higher than in FIG. 7A and FIG. 7B. For example, the initial measured cell voltage may be 4.1V. As a result of the SOCi being greater than 50% and less than or equal to 80%, the battery may be charged with a current limit determined in accordance with the third lookup table. The battery receives the charge and the measured SOC increases. The battery continues to be charged based on an interpolation (rounding down, etc.) of values retrieved from lookup table 604. During charging of the battery, the various current limits may be retrieved and used to estimate a charging current limit to apply at a specific time, based on an interpolated measured cell voltage and temperature, as described above. Charging may continue until a high SOC threshold (e.g., the high-SOC threshold of the battery. As a result of reaching the high-SOC threshold (e.g., 80% of the battery), the current limit may be adjusted to the final current limit selected in accordance with the high-voltage lookup table. The battery may be charged in accordance with the final limit until charging is terminated.

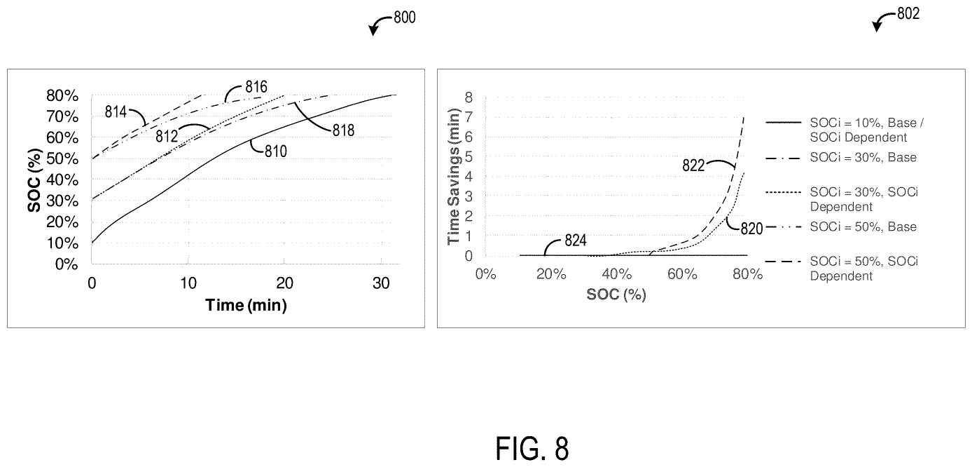

Thus, as seen in timing diagrams 700, 730, and 750, as the SOC of the battery approaches a maximum SOC of the battery, the current used to charge the battery may be advantageously increased when the SOCi is higher, with respect to an alternative scenario where the SOCi is not considered in determining current limits. That is, the third current limit used to charge the battery may be higher in timing diagram 750 when the SOCi is 65%, than in timing diagram 730, when the SOCi is 45%, and higher than in timing diagram 700, when the SOCi is 20%. By adjusting the current limits in this manner, a charging rate of the battery may be increased and a time spent charging the battery may be decreased. The reduction in time spent charging the battery is shown in FIG. 8.

Turning to FIG. 8, a first charging time graph 800 is shown that includes a plurality of plots indicating relative charging rates of the EV/battery under different scenarios. A first line 810 indicates a first charging rate, when the SOCi is 10% of battery capacity. Line 810 may correspond to a conventional determination of current limits, where the current limits are not adjusted based on SOCi as described herein (as in timing diagram 700). At the first charging rate, the battery takes over 30 minutes to charge to 80% capacity. As described above, after 80%, a lower current limit that is not based on SOCi may be applied.

A second line 812 indicates a second charging rate, when the SOCi is 30% of battery capacity and the charging current limit is adjusted based on the SOCi, in accordance with method 200. At the second charging rate, the battery charges to 80% capacity in approximately 20 minutes. The second charging rate may be compared with a first reference charging rate indicated by a line 818, corresponding to a scenario where the charging current limit is adjusted based on temperature and SOC, but not adjusted based on SOCi. At the first reference charging rate, the battery charges to 80% capacity in approximately 25 minutes. Thus, adjusting the current limit based on the SOCi results in approximately 20% reduction in charging time, for an SOCi of 30%.

A third line 814 indicates a third charging rate, when the SOCi is 50% of battery capacity and the charging current limit is adjusted based on the SOCi, in accordance with method 200. At the third charging rate, the battery charges to 80% capacity in approximately 11 minutes. The third charging rate may be compared with a second reference charging rate indicated by a line 816, corresponding to a scenario where the charging current limit is adjusted based on temperature and SOC, but not adjusted based on SOCi. At the second reference charging rate, the battery charges to 80% capacity in approximately 18 minutes. Thus, adjusting the current limit based on the SOCi results in approximately a 38% reduction in charging time, for an SOCi of 50%.

The savings in charging time represented by the second charging rate and the third charging rate are shown as a function of SOC in a second charging time graph 802. A first line 820 shows that as the SOC increases during charging, the time savings generated by applying a current limit based on an SOCi of 30% begins to accrue at approximately 40% of battery capacity, and the time savings increases to a total of approximately 4 minutes at 80% of battery capacity, with respect to a baseline time 824 where the current limit is not adjusted based on the SOCi of 30%. A second line 822 shows that as the SOC increases during charging, the time savings generated by applying a current limit based on an SOCi of 50% begins to accrue at approximately 50% of battery capacity, and the time savings increases to a total of approximately 7 minutes at 80% of battery capacity, with respect to baseline time 824 where the current limit is not adjusted based on the SOCi of 50%.

The technical effect of adjusting the charging current limit during charging of a battery by an amount based on an SOCi of the battery is that an overall charging rate of the battery may be increased, and an amount of time taken to charge the battery may be reduced.

The disclosure also provides support for a method for charging an electric vehicle (EV) using direct current fast charging (DCFC), the method comprising: initiating charging of a battery of the EV with a first charging current that is less than or equal to a first DCFC current limit generated based on an initial state of charge (SOCi) of the battery prior to receiving a charge from a DCFC charger, and continuing charging the battery with a second charging current that is less than or equal to a second DCFC current limit with a measured state of charge (SOC) of the battery above a threshold SOC, the second charging current less than or equal to the first charging current and the second DCFC current limit based on the SOCi, the second DCFC current limit less than or equal to the first DCFC current limit. In a first example of the method, generating the first DCFC current limit and generating the second DCFC current limit further comprise selecting the first DCFC current limit and the second DCFC current limit, respectively, from a plurality of DCFC charging current limits stored in a lookup table in a memory of the EV, based on at least the measured SOC, a measured temperature, and the SOCi of the battery. In a second example of the method, optionally including the first example, the first DCFC current limit and the second DCFC current limit are selected from the lookup table additionally based on a state of health (SOH) of the battery. In a third example of the method, optionally including one or both of the first and second examples, generating the first DCFC current limit and generating the second DCFC current limit further comprise: retrieving one or more voltage threshold adjustments from a first lookup table, based on the SOCi and the temperature, adjusting the measured voltage by the one or more voltage threshold adjustments, retrieving a DCFC current limit from a second lookup table, based on the adjusted voltage and the temperature. In a fourth example of the method, optionally including one or more or each of the first through third examples, the one or more voltage threshold adjustments are generated using a transfer function, where at least the temperature and the SOCi of the battery are inputs to the transfer function. In a fifth example of the method, optionally including one or more or each of the first through fourth examples, the plurality of DCFC charging current limits are generated using a calibrated physical battery model of the battery, the physical battery model generated from degradation data, battery cell voltage data, and temperature data of the battery. In a sixth example of the method, optionally including one or more or each of the first through fifth examples, the degradation data includes empirical lithium plating data. In a seventh example of the method, optionally including one or more or each of the first through sixth examples, the first DCFC current limit and the second DCFC current limit are generated using a model trained on the degradation data, battery cell voltage data, and temperature data of the battery, where at least a measured cell voltage, a temperature, and the SOCi of the battery are inputs to the model. In a eighth example of the method, optionally including one or more or each of the first through seventh examples, the model is a machine learning (ML) model. In a ninth example of the method, optionally including one or more or each of the first through eighth examples, the method further comprises: charging the battery using a plurality of different charging currents, each charging current of the plurality of different charging currents established by a respective DCFC current limit selected based on the SOCi, each charging current having a different voltage threshold.

The disclosure also provides support for a method, comprising: creating a plurality of direct current fast charging (DCFC) current limits for an electric vehicle (EV) based on a calibrated physical battery model of a battery of the EV, the physical battery model generated from degradation data, voltage data, and state of charge (SOC) data of the battery, storing the plurality of DCFC charging current limits in a memory of the EV, and during charging of the EV: measuring an initial SOC (SOCi) of the battery prior to receiving a charge from a DCFC charger, selecting a first DCFC current limit from the plurality of DCFC charging current limits, based on the SOCi, initiating charging the battery in accordance with the first DCFC current limit, in response to an SOC of the battery achieving a first threshold SOC: selecting a second DCFC current limit from the plurality of DCFC charging current limits, based on the SOCi, the second DCFC current limit less than or equal to the first DCFC current limit, continuing charging the battery in accordance with the second DCFC current limit. In a first example of the method, the method further comprises: in response to the SOC of the battery achieving a second threshold SOC: selecting a third DCFC current limit from the plurality of DCFC charging current limits, based on the SOCi, continuing charging the battery in accordance with the third DCFC current limit. In a second example of the method, optionally including the first example, the plurality of DCFC charging current limits are dependent on the SOCi, a measured voltage, and a temperature of the battery. In a third example of the method, optionally including one or both of the first and second examples, the plurality of DCFC charging current limits are additionally dependent on a state of health (SOH) of the battery. In a fourth example of the method, optionally including one or more or each of the first through third examples, the plurality of DCFC charging current limits are selected from one or more look-up tables stored in the memory of the EV.

The disclosure also provides support for a system for configuring electric vehicles (EVs) for direct current fast charging (DCFC), comprising: a plurality of physical battery models corresponding to a respective plurality of batteries used by the EVs, a processor, and a memory storing instructions that when executed, cause the processor to: for each battery of the plurality of batteries: using a physical battery model corresponding to the battery, generate a plurality of DCFC charging current profiles to be used to charge the battery as a function of a measured state of charge (SOC), for a plurality of battery temperatures and a plurality of initial SOCs (SOCi) of the battery, extract, from the plurality of profiles, suitable charging current limits associated with respective measured SOCs, battery temperatures, and SOCis, store the suitable charging current limits in one or more lookup tables to be stored in the EVs. In a first example of the system, the one or more lookup tables include a first lookup table indicating suitable charging currents for the battery as a function of the measured SOC and battery temperature, and a second lookup table indicating a voltage threshold adjustment to be made to the measured SOC, based on the SOCi, prior to using the first lookup table. In a second example of the system, optionally including the first example, the voltage threshold adjustment to be made to the measured voltage based on the SOCi is calculated using a transfer function generated based on outputs of the physical battery model. In a third example of the system, optionally including one or both of the first and second examples, a physical battery model of a battery is used to generate training data used to train a machine learning (ML) model to output a suitable charging current to charge the battery based on inputs including an SOCi, a temperature, and a measured SOC of the battery. In a fourth example of the system, optionally including one or more or each of the first through third examples, one or more of the one or more lookup tables, a transfer function, and the model are stored in an EV having the battery, and a current is received to charge the battery from a direct current fast charging (DCFC) charger based on a current limit retrieved from the one or more lookup tables or outputted by the model.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for charging an electric vehicle using direct current charging, the method comprising:
initiating charging of a battery of the electric vehicle with a first charging current limited to a first current limit based on an initial state of charge of the battery prior to receiving a charge from a direct current charging charger; and
continuing charging the battery with a second charging current limited to a second current limit, lower than the first current limit, based on a state of charge of the battery and the initial state of charge of the batter, the second charging current less than or equal to the first charging current.

2. The method of claim 1, wherein the first current limit and the second current limit further are based on a plurality of charging current limits stored as a function of at least or more of the measured voltage, a measured temperature, and/or the initial state of charge of the battery.

3. The method of claim 2, wherein the first current limit and the second current limit are further based on a state of health and state of charge of the battery.

4. The method of claim 1, wherein the electric vehicle is one or more of a plugin hybrid vehicle, a range extended hybrid vehicle, an electric traction or battery or plugin vehicle.

5. The method of claim 4, the first and second current limits are repeatedly stepped lower as charging time increases.

6. The method of claim 2, wherein the first and second current limits are based on a calibrated physical battery model of the battery, the physical battery model generated from degradation data.

7. The method of claim 6, wherein the degradation data includes empirical lithium plating data.

8. The method of claim 6, wherein the first current limit and the second current limit are generated using a model trained on the degradation data.

9. The method of claim 8, where the model is a machine learning model.

10. The method of claim 1, further comprising charging the battery using a plurality of different charging currents, each charging current of the plurality of different charging currents established by a respective current limit selected based on the initial state of charge of the battery, each charging current having a different voltage threshold.

11. A method, comprising:
creating a plurality of direct current fast charging current limits for an electric vehicle based on a calibrated physical battery model of a battery of the electric vehicle, the physical battery model generated from degradation data, voltage data, and state of charge data of the battery;
storing the plurality of charging current limits in a memory of the electric vehicle; and
during charging of the electric vehicle:
selecting a first current limit from a plurality of charging current limits based on the initial state of charge prior to receiving a charge from a direct current fast charging charger;
initiating charging the battery in accordance with the first current limit;
in response to a state of charge of the battery achieving a first threshold:
selecting a second current limit from the plurality of charging current limits, based on the initial state of charge, the second current limit less than or equal to the first current limit;
continuing charging the battery in accordance with the second current limit.

12. The method of claim 11, further comprising:
in response to the state of charge of the battery achieving a second threshold state of charge:
selecting a third current limit from the plurality of charging current limits, based on the initial state of charge;
continuing charging the battery in accordance with the third current limit.

13. The method of claim 11, wherein the plurality of charging current limits are dependent on the initial state of charge, a measured voltage, and a temperature of the battery.

14. The method of claim 13, wherein the plurality of DCFC charging current limits are additionally dependent on a state of health of the battery.

15. The method of claim 11, wherein the plurality of charging current limits are selected from one or more look-up tables stored in the memory of the electric vehicle.

16. A system for configuring electric vehicles for direct current fast charging, comprising:
a plurality of physical battery models corresponding to a respective plurality of batteries used by the electric vehicle;
a processor, and a memory storing instructions that when executed, cause the processor to:
for each battery of the plurality of batteries:
using a physical battery model corresponding to the battery, generate a plurality of charging current profiles to be used to charge the battery as a function of a measured state of charge, for a plurality of battery temperatures and a plurality of initial states of charge of the battery;
extract, from the plurality of charging current profiles, suitable charging current limits associated with respective measured voltages, measured states of charge, battery temperatures, and initial states of charge;
store the suitable charging current limits in one or more lookup tables to be stored in the electric vehicles.

17. The system of claim 16, wherein the one or more lookup tables include a first lookup table indicating suitable charging currents for the battery as a function of the measured voltage and battery temperature, and a second lookup table indicating a voltage threshold adjustment to be made to the measured state of charge, based on the initial state of charge prior to using the first lookup table.

18. The system of claim 17, wherein the voltage threshold adjustment to be made to the measured voltage based on the initial state of charge is calculated using a transfer function generated based on outputs of the physical battery model.

19. The system of claim 16, wherein a physical battery model of a battery is used to generate training data used to train a machine learning (ML) model to output a suitable charging current to charge the battery based on inputs including a temperature, and a measured state of charge of the battery.

20. The system of claim 19, wherein one or more of the one or more lookup tables, a transfer function, and the model are stored in an EV having the battery, and a current is received to charge the battery from a direct current fast charging charger based on a current limit retrieved from the one or more lookup tables or outputted by the model.
